(19) United States
(12) Patent Application Publication
(10) Pub. No.: US 2019/0300140 A1
(43) Pub. Date: Oct. 3, 2019

(54) NOVEL STORAGE COMPARTMENT IN THE NOSE SECTION OF AN AIRCRAFT, NOTABLY AN AIRCRAFT DEDICATED TO THE CARRIAGE OF PASSENGERS AND/OR OF FREIGHT AND TO THE AIRCRAFT PROVIDED WITH SUCH A COMPARTMENT

(71) Applicant: Airbus Operations (S.A.S.), Toulouse (FR)

(72) Inventors: Bernard Guering, Montrabe (FR); Laurent Saint-Marc, Montaigut Sur Save (FR)

(21) Appl. No.: 16/363,543

(22) Filed: Mar. 25, 2019

(30) Foreign Application Priority Data
Mar. 30, 2018 (FR) 1852828

(51) Int. Cl. B64C 1/10; B64C 1/14

(52) U.S. Cl. CPC B64C 1/10; B64C 1/1469

(57) ABSTRACT

Attempts are increasingly being made to optimize space in the flight decks of aircraft to reduce the overall volume thereof with a view to increasing that of the profit-making zones such as the cabin. To this end, the present disclosure relates to a nose section of an aircraft including a cockpit separated from a cabin by a bulkhead. The bulkhead includes a recess projecting from the surface of the bulkhead on the cabin side, laterally offering hollow zones closed by at least one closure wall to create at least one storage compartment. The volume gained in the cabin allows for the storage of cockpit equipment, thus allowing cockpit volume to be optimized.

### CROSS-REFERENCE TO RELATED APPLICATION

This application claims priority to French patent application number 18 52828 filed on Mar. 30, 2018, the entire disclosure of which is incorporated by reference herein.

### TECHNICAL FIELD

The disclosure herein relates to a novel storage compartment in the nose section of an aircraft, notably an aircraft dedicated to the carriage of passengers and/or of freight and to the aircraft provided with such a compartment.

### BACKGROUND

The nose section of an aircraft is a complex assembly in which numerous items of equipment are stored, notably survival equipment to which the pilot or pilots need quick and easy access, such as, for example, an oxygen mask, or else safety equipment such as, for example, a fire extinguisher, a medical kit, an axe, or even personal effects specific to the pilot, such as, for example, jacket, case. However, the airlines are seeking to increase the number of seats, which entails a cabin the volume of which increases at the expense of the volume allocated to the flight deck. In fact, the airlines are seeking to increase the size of all the areas that allow them to make profit, such as the cabin or the cargo area, and to reduce that of the areas dedicated to technical functions, such as the cockpit area. It is therefore necessary to optimize the use of space in the flight deck in order to reduce the overall volume thereof with a view to increasing that of the profitable areas such as the cabin.

A lateral equipment storage unit of optimized architecture is known from patent FR3050434 filed on 26 Apr. 2016. That device does, however, have the disadvantage of occupying a great deal of space in the cockpit. Now, it is necessary to reduce the space taken up by such storage spaces with a view to reducing the volume of the cockpit.

### SUMMARY

It is an object of the disclosure herein to propose a novel storage compartment that makes it possible to free up space in the cockpit area.

The disclosure herein relates to a nose section of an aircraft comprising a cockpit separated from a cabin by a bulkhead, wherein the bulkhead comprises a recess which forms a protrusion from the surface of the bulkhead on the cabin side, laterally offering at least one hollow zone closed by at least one closure wall to create at least one storage compartment, at least one opening being made in the bulkhead to access the inside of the storage compartment from the cockpit

In this way, the storage compartment the volume of which is taken from the cabin space can be used to house cockpit equipment, freeing up a corresponding amount of cockpit space and making it possible to optimize the cockpit space using the volume gained.

The disclosure herein has at least one of the following optional features, considered in isolation or in combination:

The opening or openings are covered by at least one protective panel that can be moved to allow access to the inside of the compartment.

The recess comprises two longitudinal walls and a transverse wall which is parallel to the bulkhead.

At least one compartment comprises a single curved closure wall.

The bulkhead comprises an access door and the recess is situated transversely at the level of the access door between the cabin and the cockpit.

The recess is situated facing the seat of a centrally-positioned pilot.

At least one storage compartment has a height shorter than that of the cabin.

A single storage compartment is provided on one side or on both sides of the recess.

Several storage compartments of different sizes are provided, vertically one on top of the other.

The disclosure herein also relates to an aircraft provided with a nose section as set out hereinabove.

### BRIEF DESCRIPTION OF THE DRAWINGS

Further objects, advantages and features of the disclosure herein will become apparent from reading the following description of the disclosure herein, given by way of nonlimiting example and with reference to the attached, example drawings in which:

FIG. 1 is a simplified side elevation of an example of an aircraft according to the prior art to which the disclosure herein can be applied;

FIG. 2 is a simplified and partial three-quarter perspective view of the inside of the cockpit of the nose section of an aircraft comprising a recess according to the disclosure herein;

FIG. 3 is a plan view of a nose section of an aircraft comprising two storage compartments according to the disclosure herein in the toilets;

FIG. 4 is a plan view of a nose section of an aircraft comprising two storage compartments according to the disclosure herein, one in the toilets and the other in a space allocated to passenger seats;

FIG. 5 is a plan view of a nose section of an aircraft comprising two storage compartments according to the disclosure herein, one in the toilet and the other in the space allocated to the galley;

FIG. 6 is a simplified and partial rear perspective view of the inside of the cabin in the nose section of the aircraft comprising a recess according to the disclosure herein; and

FIG. 7 is a simplified and partial plan view of the cockpit according to FIG. 2,

### DETAILED DESCRIPTION

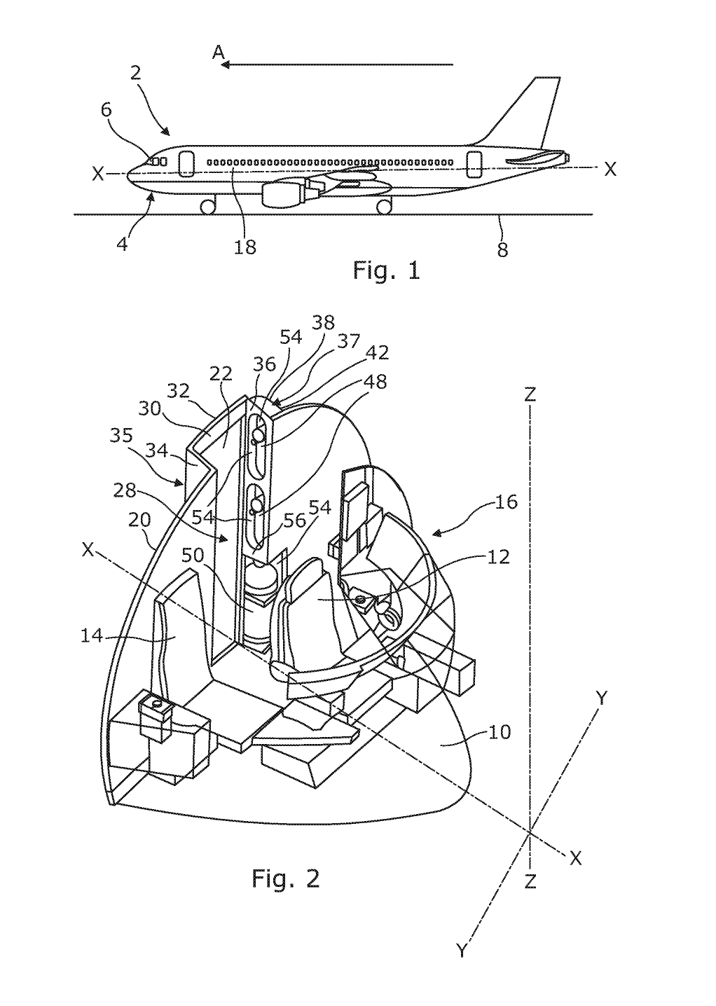

FIGS. 1 through 7 depict an aircraft 2 having a nose section 4 comprising a cockpit 6.

In the remainder of the description, it is assumed that the aircraft 2 is on a ground 8 defining a horizontal plane. The aircraft 2 comprises a floor 10 arranged parallel to the ground namely at a horizontal plane. The floor 10 is a floor for the members of the crew (pilot, co-pilot, flight assistant, attendants . . . ) and/or for the passengers to walk on. A vertical direction is a direction perpendicular to the horizontal planes of the ground and of the floor. Throughout the following description, by convention, the longitudinal direction of the aircraft, which is in a horizontal plane, is referred to as X, the direction running transversely with respect thereto is referred to as Y and the vertical or heightwise direction is referred to as Z, these three directions X, Y and Z being mutually orthogonal.

The terms front and rear are used with reference to the direction in which the aircraft travels in flight, as indicated by the arrow A in FIG. 1.

Evolutions in flight deck design are leading towards an aircraft being flown by a pilot in a pilot seat 12 which is positioned centrally in the transverse direction Y. An aircraft is flown by a single pilot or by a pilot assisted by an individual who does not perform flying duties but acts merely as an assistant. In both instances, the pilot is positioned on the seat 12 in the vertical plane containing the central longitudinal axis X of the aircraft that passes through the front end of the aircraft and the flight control systems are arranged around the pilot, so that they are centred on him. In the event that there is an additional individual assisting the pilot, this individual is positioned on a co-pilot seat 14 which is offset from the pilot rearward and to one of the sides of the pilot.

In the remainder of the description, whatever the configuration, a pilot positioned transversely in the centre of the cockpit will be referred to as a centrally-positioned pilot.

The disclosure herein applies to any type of flight deck and advantageously to a flight deck with a centrally positioned pilot as will be seen from the description of one illustrative embodiment in what follows.

As shown in FIGS. 1 through 7, the cockpit 6 comprises a flight deck 16 in which a pilot is positioned on a seat 12 transversely in the Y direction centrally, namely positioned on the central longitudinal axis X. A co-pilot is positioned on a seat 14 which is offset toward the rear and one of the sides of the pilot. It is possible for the co-pilot to be a mere assistant who has no flying function.

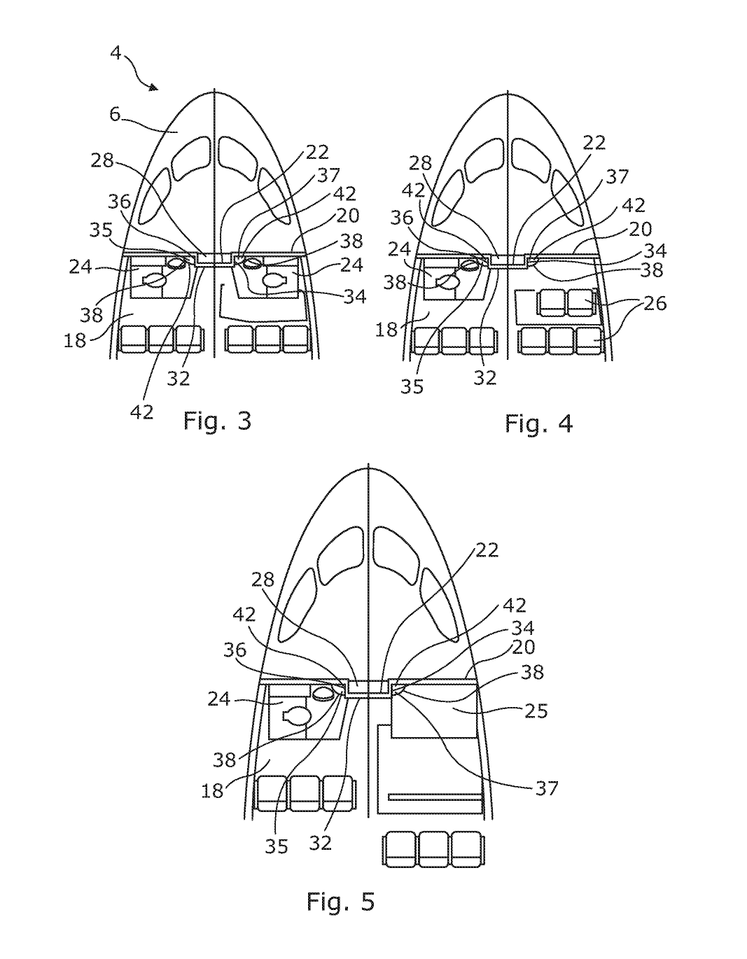

In most present-day airplanes, the cockpit 6 is separated from a cabin 18 by an armored bulkhead 20 provided with an access door 22. The cabin in this instance is considered in the broad sense, namely that it encompasses any area contiguous with the cockpit and which might not contain passenger seats as in FIGS. 3 and 5. The door 22 is positioned centrally transversely in Y and therefore lies on the same longitudinal axis X as the pilot seat 12 in the centrally-positioned pilot configuration.

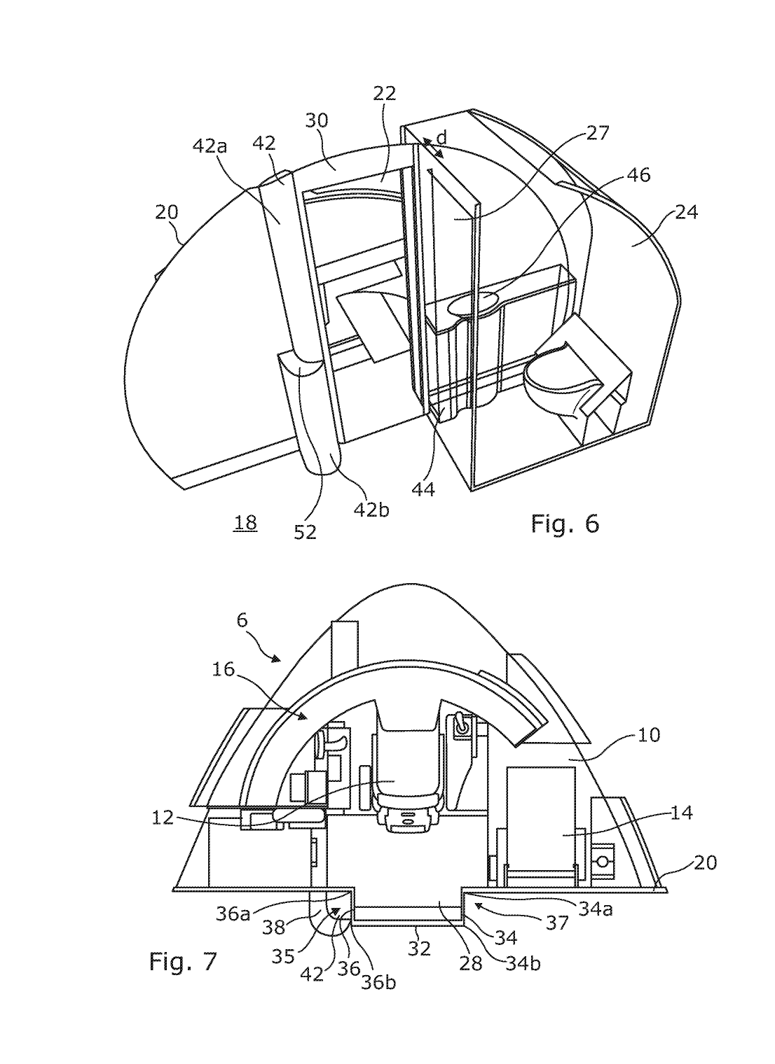

The cabin 18 may exhibit various types of layout in the vicinity of the cockpit, such as, for example:
Toilets 24 contiguous with the cockpit bulkhead 20 and positioned on both sides of the door in the bulkhead, as depicted in FIG. 3;
Toilets 24 and a galley 25 contiguous with the cockpit 6 bulkhead 20 and positioned on either side of the door 22 in the bulkhead in a direction transverse to the airplane as illustrated in FIG. 5;
Toilets 24 contiguous with the cockpit 6 bulkhead 20 and passenger seats 26 positioned right up against the bulkhead 20 and positioned on either side of the door in the bulkhead in a direction Y transverse to the airplane as illustrated in FIG. 4 or alternatively in FIG. 6 in which the seats are not visible.

Very few airplanes have toilets assigned to the sole use of the pilots. The pilots have to leave the cockpit in order to use the toilets intended for the passengers. The pilots may also wish to access the cabin for example in order to check the status of an airplane system. The cabin area contiguous with the cockpit area is therefore an area frequented by the pilot.

Whatever the configuration, the space d (FIG. 6) between the bulkhead 20 and the toilet door 27 measured along the longitudinal axis X is unused. The disclosure herein comprises or consists in using this space to locally increase the extent of the cockpit 6 and create spaces in which cockpit 6 equipment can be stored.

The bulkhead 20 has a recess 28. The term “recess” is to be considered in a very broad sense, namely as something that forms an alcove, a hollow part that, as will be detailed later on, allows the creation of at least one storage compartment that can be accessed from the cockpit. In the embodiment illustrated in FIGS. 2 to 7, the recess 28 is positioned, transversely in the Y direction, contiguous with the frame 30 of the access door and the access door 22 itself. However, the recess could be offset transversely from the centre of the bulkhead.

The door frame 30 and the door 22 are offset longitudinally in the X direction in a transverse plane in the Y-direction that is parallel to the plane of the bulkhead 20. The recess 28 has a rectangular transverse wall 32 parallel to the plane of the bulkhead and two longitudinal rectangular walls 34, 36 in the X-direction that are parallel to one another and perpendicular to the transverse wall 32.

In the illustrated embodiment of a centrally-positioned pilot, the recess 28 lies facing the pilot seat 12. Thus, when an individual such as an attendant or the co-pilot accesses the cockpit 6, the space he or she finds themselves in is larger, making it possible not to hinder the pilot in his work. Furthermore, it leaves a larger area into which to deploy the pilot seat 12 in the rest position.

The recess 28 creates a protrusion from the bulkhead on the cabin side, thus creating two hollow areas 35, 37 on either side of the recess and able to form housings. In the embodiment illustrated, each longitudinal wall 34, 36 of the recess forms, with the bulkhead, an L-shape, the hollow area being closed by at least one third, closure, wall 38. Each wall 34, 36 comprises two lateral ends 34a, 34b, 36a, 36b (FIG. 7): one of the ends 34a, 36a is joined to the bulkhead and the other two ends 34b and 36b are joined to one another via the door frame 30 and the door 22. Still in the embodiment illustrated, the third wall 38 is curved and joins the respective lateral end 34b, 36b of the longitudinal wall to the bulkhead 20, thus creating a closed compartment 42 referred to as a storage compartment.

Any other form of embodiment that makes it possible to create a compartment from the hollow areas formed by the way in which the recess 28 protrudes is possible; thus, for example, several flat closure walls could be abutted edge to edge to close the hollow areas and create the compartment 42.

The closure walls 38 are opaque. Because they are incorporated into the bulkhead, they likewise have a reinforced structure protecting access to the cockpit 6.

In the embodiment illustrated, the third, closure wall 38 is semi-circular. In that case, the distance separating the end 34a, 36a on the one hand, at the end of the wall 38 connected to the bulkhead and, on the other hand, at the end 34b, 36b is identical.

Just one compartment 42 may be created on just one of the lateral sides of the recess, as in FIGS. 2, 6 and 7.

In the embodiments illustrated in FIGS. 3 through 5, two storage compartments are provided, one on each side of the recess.

In FIG. 3, the spaces allocated to the compartments 42 are taken from inside the toilets 24. As shown in FIG. 6, this space is occupied by the boxing-in 44 of the basin 46. The compartment 42 then replaces the boxing-in 44 and does not take up additional space. It is therefore of no inconvenience to the passenger and allows the boxing-in 44 to adopt an additional technical function outside of its aesthetic function.

In FIG. 4, the space for one of the compartments is taken, as before, from one of the toilets, and the space for the other compartment is taken from the passenger space

In FIG. 5, the space for one of the compartments is taken as before from one of the toilets and the space for the other compartment is taken from a galley space. It will then be necessary to replace a trolley by a half-trolley because of the volume given over to the storage compartment 42.

The storage compartment 42, of which the height, in the example illustrated, is that of the cabin, has dimensions allowing it to house equipment such as smoke goggles, an axe for breaking the access door, fire-resistant gloves, a light, etc.; in the example illustrated in FIG. 2, it houses fire extinguishers 48 and an oxygen cylinder 50.

A plurality of compartments 42 of different sizes may be provided one above the other in the vertical direction Z as visible for example in the embodiment of FIG. 6.

One single compartment 42 of a dimension shorter than that of the cabin, or else than that of the door 22, and for example coming approximately mid-way up this door may be provided, so as to limit the space occupied by the compartment towards the top for the sake of the passengers, but also to offer a horizontal shelf on which objects can be placed and allowing an individual wishing to access the storage compartment to keep their hands free.

In the example illustrated in FIG. 6, two storage compartments 42a, 42b are provided one on top of the other in the height of the cabin. The larger compartment 42b is at the bottom so as, as in the embodiment discussed hereinabove, to offer a practical shelf 52.

Access to the inside of the compartment 42 may be achieved in a number of ways. Openings 54, visible in FIG. 2, are made in the recess at the bulkhead 20 on the cockpit side. More specifically, in the embodiment illustrated, the openings are made in the longitudinal wall 36 of the compartment 42. The pilot thus has quick and easy access to these compartments. They may be provided in the transverse wall 20 of the compartment 42.

The openings 54 are covered by a protective panel 56. In the embodiment illustrated in FIG. 2 the panel 56 is transparent so that the contents of the compartment 42 can be seen and the correct presence of the necessary equipment can be checked at a glance. However, the panel could be opaque or else provided with a window making it possible to see into the compartment 42. The panel 56 may be moved to allow access to the inside of the compartment; it may be articulated to rotate, removable or demountable. It is provided with the structure or means necessary for moving it in order to access the inside of the compartment in each instance. It is for example provided, in the case of an articulated panel, with structure or means allowing such articulation, such as hinges, and with structure or means for grasping the panel in order to pivot it, such as a handle. In the case of a removable panel, the panel is provided for example with clips, with self-gripping structure or means, magnets, etc. and with structure or means allowing the panel to be grasped in order to detach it, such as a handle for example. Finally, it may be fixed in a demountable way using structure or means such as screws for example.

The compartments 42 thus formed are very easy to access. The volumes they offer have been transferred from the cockpit to the cabin.

The volume transferred into the cabin is a volume taken from the toilets or from the cockpit entry zone which is unused.

The volume of the recess added to the cockpit allows better access to the cockpit without disturbing the pilot at the controls. It also offers an additional volume in which to recline the pilot seat 12 in the rest position.

The volume gained in the cabin makes it possible to house cockpit equipment and optimize the volume so as to meet the objectives of cockpit volume reduction.

Various modifications can be made by those skilled in the art to the embodiments which have been just been described solely by way of examples.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nose section of an aircraft comprising:
a cockpit separated from a cabin by a bulkhead;
the bulkhead comprising a recess which forms a protrusion from a surface of the bulkhead on a cabin side, laterally offering at least one hollow zone closed by at least one closure wall to create at least one storage compartment; and
at least one opening in the bulkhead to access an inside of the storage compartment from the cockpit.

2. The nose section of an aircraft according to claim 1, wherein the opening or openings are covered by at least one protective panel that can be moved to allow access to the inside of the storage compartment.

3. The nose section of an aircraft according to claim 1, wherein the recess comprises two longitudinal walls and a transverse wall which is parallel to the bulkhead.

4. The nose section of an aircraft according to claim 1, wherein at least one storage compartment comprises a single curved closure wall.

5. The nose section of an aircraft according to claim 1, wherein the bulkhead comprises an access door and wherein the recess is situated transversely at a level of the access door between the cabin and the cockpit.

6. The nose section of an aircraft according to claim 1, wherein the recess is situated facing a seat of a centrally-positioned pilot.

7. The nose section of an aircraft according to claim 1, wherein at least one storage compartment has a height shorter than a height of the cabin.

8. The nose section of an aircraft according to claim 7, wherein a single storage compartment is provided on one side or on both sides of the recess.

9. The nose section of an aircraft according to claim 1, comprising several storage compartments of different sizes, vertically one on top of another.

10. An aircraft comprising a nose section, the nose section comprising:
a cockpit separated from a cabin by a bulkhead;
the bulkhead comprising a recess which forms a protrusion from a surface of the bulkhead on a cabin side, laterally offering at least one hollow zone closed by at least one closure wall to create at least one storage compartment; and
at least one opening in the bulkhead to access an inside of the storage compartment from the cockpit.
